(19) United States
(12) Patent Application Publication
(10) Pub. No.: US 2021/0168051 A1
(43) Pub. Date: Jun. 3, 2021

(54) NETWORK CONTROL APPARATUS, NETWORK CONTROL METHOD AND PROGRAM

(71) Applicant: Nippon Telegraph and Telephone Corporation, Tokyo (JP)

(72) Inventors: Takafumi OKUYAMA, Tokyo (JP); Hiroshi INOUE, Tokyo (JP); Kenichi ENDO, Tokyo (JP); Toshiaki Tsuchiya, Tokyo (JP); Seisho YASUKAWA, Tokyo (JP)

(21) Appl. No.: 17/267,850

(22) PCT Filed: Aug. 2, 2019
(86) PCT No.: PCT/JP2019/030446

§ 371 Date: Feb. 11, 2021

(30) Foreign Application Priority Data
Aug. 13, 2018 (JP) 2018-152355

(51) Int. Cl. H04L 12/24; H04L 29/08; H04L 12/725; H04L 12/707

(52) U.S. Cl. CPC H04L 41/5009; H04L 41/5025; H04L 45/22; H04L 45/302; H04L 67/322

(57) ABSTRACT

Included are a communication quality requirement derivation unit that derives, for a specific service session between a server and a terminal, a communication quality requirement to be satisfied between the server and the terminal based on a requested quality of experience of the specific service session; a monitoring unit that monitors a communication quality of the specific service session between the server and the terminal; a determination unit that determines whether the communication quality of the specific service session satisfies the communication quality requirement derived for the specific service session; and a control unit that controls, when the communication quality of the specific service session does not satisfy the communication quality requirement derived for the specific service session, a communication route used for the specific service session between the server and the terminal so as to satisfy the communication quality requirement.

### TECHNICAL FIELD

The present invention relates to a network control device, a network control method, and a program.

### BACKGROUND ART

Generally, in a video distribution service, a video content is reproduced while sequentially downloading previously divided pieces of video data (also referred to as segment files or chunks) and storing them in a buffer of a client. When the communication quality is degraded, the client dynamically adjusts the image quality and the download timing to attempt to prevent the degradation of user quality of experience (QoE). If the client cannot perform the dynamic adjustment to follow the degradation of the communication quality, an event (rebuffering) occurs in which the data in the buffer is exhausted and the reproduction is temporarily interrupted, resulting in the degraded QoE.

In order to maintain the QoE requested by a content distributor for the video distribution service (requested QoE), a network provider needs to monitor the communication quality to perform appropriate network control.

As an example of network control that allows network providers to perform, there is a technique for monitoring communication quality to detour traffic (PTL 1). Further, there is a technique for performing network control so that users satisfy the requested QoE (NPL 1).

### CITATION LIST

### Patent Literature

[PTL 1] Japanese Patent Application Publication No. 2018-085585

### Non Patent Literature

[NPL 1] Yasushi Kanada, “Prototype Development of A Network Control Mechanism That Satisfies Requests on User-level Communication Quality”, Technical Report of Institute of Electronics, Information and Communication Engineers, vol. 109, IN2009 1-11, pp. 25-30, May 2009

### SUMMARY OF THE INVENTION

### Technical Problem

In order to maintain the requested QoE of a content distributor, a network provider can monitor the communication quality of the network, and provide, when the QoE is degraded, a detour route (bypass) that avoids a congestion point (bottleneck). Generally, the communication quality of the bypass needs to be strictly controlled, which requires an additional cost for use of the bypass. Therefore, from the viewpoints of network providers and content distributors, it is desirable to maintain the QoE, and to divert to a bypass only a specific service session that cannot satisfy the requested QoE due to a congestion point.

In PTL 1, it is considered to monitor communication quality to divert traffic. However, it is intended to uniformly divert based on congestion detection, and accordingly there is no function of inputting QoE requested by a content distributor or no function of determining whether or not diversion control is required based on the requested QoE on a service session basis. In other words, there is a problem that it is not possible to individually perform network control for a specific service session based on the requested QoE.

On the other hand, in NPL 1, it is considered to map a requested QoE input by a user to a QoS (Quality of Service) to set the QoE in each network node. However, the control targets in NPL 1 are all of the communications, and accordingly there is no function of allowing a content distributor to set the requested QoE on a service session basis. In other words, there is a problem that it is not possible to individually perform network control for a specific service session based on the requested QoE, and there is also a problem that the processing load is high because all of the communications are to be controlled.

The present invention has been made in view of the foregoing, and an object of the present invention is to perform network control based on a requested QoE for a specific service session.

### Means for Solving the Problem

A network control device according to an aspect of the present invention includes

a communication quality requirement derivation unit that derives, for a specific service session between a server and a terminal, a communication quality requirement to be satisfied between the server and the terminal based on a requested quality of experience of the specific service session; a monitoring unit that monitors a communication quality of the specific service session between the server and the terminal;

a determination unit that determines whether the communication quality of the specific service session satisfies the communication quality requirement derived for the specific service session; and

a control unit that controls, when the communication quality of the specific service session does not satisfy the communication quality requirement derived for the specific service session, a communication route used for the specific service session between the server and the terminal so as to satisfy the communication quality requirement.

Further, a network control method according to an aspect of the present invention is

a network control method performed by a network control device, and includes the steps of:

deriving, for a specific service session between a server and a terminal, a communication quality requirement to be satisfied between the server and the terminal based on a requested quality of experience of the specific service session;

monitoring a communication quality of the specific service session between the server and the terminal; determining whether the communication quality of the specific service session satisfies the communication quality requirement derived for the specific service session; and

controlling, when the communication quality of the specific service session does not satisfy the communication quality requirement derived for the specific service session, a communication route used for the specific service session between the server and the terminal so as to satisfy the communication quality requirement.

Further, a program according to an aspect of the present invention causes

a computer to function as the respective units of the above network control device.

### Effects of the Invention

It is possible to perform network control based on a requested QoE for a specific service session.

### BRIEF DESCRIPTION OF DRAWINGS

FIG. 1 is a diagram illustrating an example of whole configuration of a system according to an embodiment of the present invention.

FIG. 2 is a diagram illustrating an example of configuration of a network control device according to the embodiment of the present invention.

FIG. 3 is a flowchart illustrating an operation procedure of the network control device according to the embodiment of the present invention.

FIG. 4 is a diagram illustrating an example of hardware configuration of the network control device according to the embodiments of the present invention.

### DESCRIPTION OF EMBODIMENTS

Hereinafter, embodiments of the present invention will be described with reference to the drawings.

The following embodiments describe a video distribution service. However, the embodiments of the present invention are also applicable to other services that establish a service session between a server and a terminal to distribute data.

### First Embodiment: Device Configuration

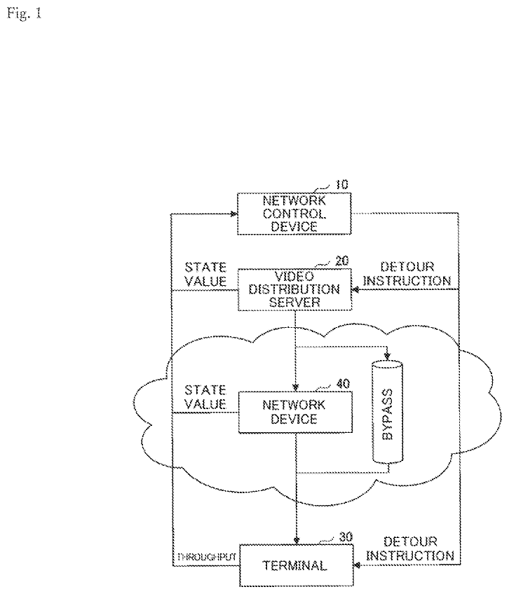

FIG. 1 is a diagram illustrating an example of whole configuration of a system according to an embodiment of the present invention. As illustrated in FIG. 1, the system according to the embodiment of the present invention includes a network control device 10, a video distribution server 20, a terminal 30, and a plurality of network devices 40.

When receiving a video distribution request from the terminal 30, the video distribution server 20 establishes a service session with the terminal 30. The service session is established for each video distribution request from the terminal 30 to the video distribution server 20. After the service session is established, the video distribution server 20 distributes a previously divided pieces of video data (hereinafter referred to as segment files) to the terminal 30. The terminal 30 stores the segment files received from the video distribution server 20 in a buffer and reproduces the segment files in the buffer.

In order to maintain a QoE requested by a content distributor (hereinafter, referred to as the requested QoE) for video distribution from the video distribution server 20 to the terminal 30, the quality of communication between the video distribution server 20 and the terminal 30 is required to be properly controlled. Here, in the embodiment of the present invention, throughput is used as an index of communication quality, but the communication quality is not limited to the throughput and may include latency, fluctuations in latency, and the like.

The terminal 30 may have a function of measuring throughput, which is an index of communication quality and transmitting the measured throughput to the network control device 10. Here, the throughput to be measured by the terminal 30 is a receivable amount of data per unit time on the terminal 30 receiving a segment file(s) from the video distribution server 20.

Further, the video distribution server 20 and the network device 40 may have a function of transmitting to the network control device 10, a state value with which throughput, which is an index of communication quality, can be estimated. An example of the state value with which throughput can be estimated is a network usage rate. For example, the throughput, which is an amount of data that can pass through the network device 40 per unit time, may be estimated based on the network usage rate of the network device 40.

Note that one or more quality measurement terminals (not illustrated) for measuring data for throughput estimation may be installed anywhere in the system. In a case where communication quality such as latency or fluctuations in latency is used, a state value that affects the communication quality is determined by a preliminary experiment or the like, and the state value is transmitted from the terminal 30, the video distribution server 20, the network device 40, the quality measurement terminal(s), and/or others to the network control device 10.

Normally, the plurality of network devices 40 are arranged in the system. For example, when it is assumed that congestion has occurred in the network device 40 illustrated in FIG. 1, a detour route (bypass) to which the network device 40 which is the congestion point can be diverted is set in the system in advance. The terminal 30 has a function of diverting the communication route to the bypass in response to a detour instruction. Further, the video distribution server 20 also has a function of diverting the communication route to the bypass in response to a detour instruction.

The network control device 10 monitors on a service session basis whether a throughput requirement that is a communication quality requirement between the video distribution server 20 and the terminal 30 is satisfied, and maintains the requested QoE of a video distribution service on a service session basis. Specifically, when the throughput requirement between the video distribution server and the terminal 30 is not satisfied, the network control device 10 issues a detour instruction for diverting the network device 40 that is the congestion point.

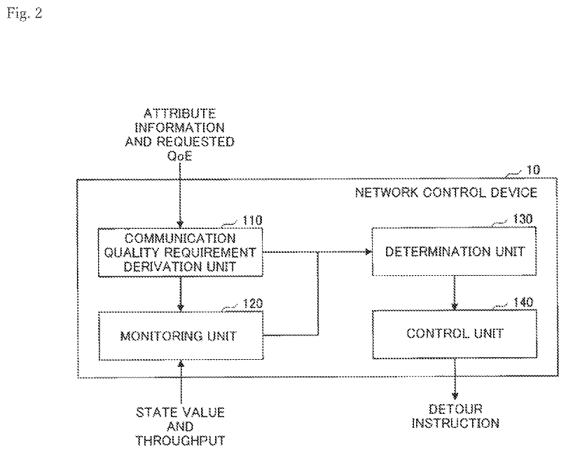

FIG. 2 is a diagram illustrating an example of configuration of the network control device 10 according to the embodiment of the present invention. As illustrated in FIG. 2, the network control device 10 includes a communication quality requirement derivation unit 110, a monitoring unit 120, a determination unit 130, and a control unit 140.

The communication quality requirement derivation unit 110 derives, for a specific service session between the video distribution server 20 and the terminal 30, the throughput requirement, which is a communication quality requirement to be satisfied between the video distribution server 20 and the terminal 30 based on the requested QoE of the specific service session.

The monitoring unit 120 monitors the throughput of the specific service session between the video distribution server 20 and the terminal 30 based on information from the video distribution server 20, the network device 40, the terminal 30, the quality measurement terminal(s), and/or others.

The determination unit 130 determines whether or not the current throughput of the specific service session monitored by the monitoring unit 120 satisfies the throughput requirement derived by the communication quality requirement derivation unit 110 for the specific service session. In this way, the determination unit 130 determines whether the current throughput satisfies the throughput requirement on a service session basis.

The control unit 140 controls, when the current throughput of the specific service session monitored by the monitoring unit 120 does not satisfy the throughput requirement derived by the communication quality requirement derivation unit 110 for the specific service session, the communication route used for the specific service session between the video distribution server 20 and the terminal 30 so as to satisfy the throughput requirement.

### First Embodiment: Operation Procedure

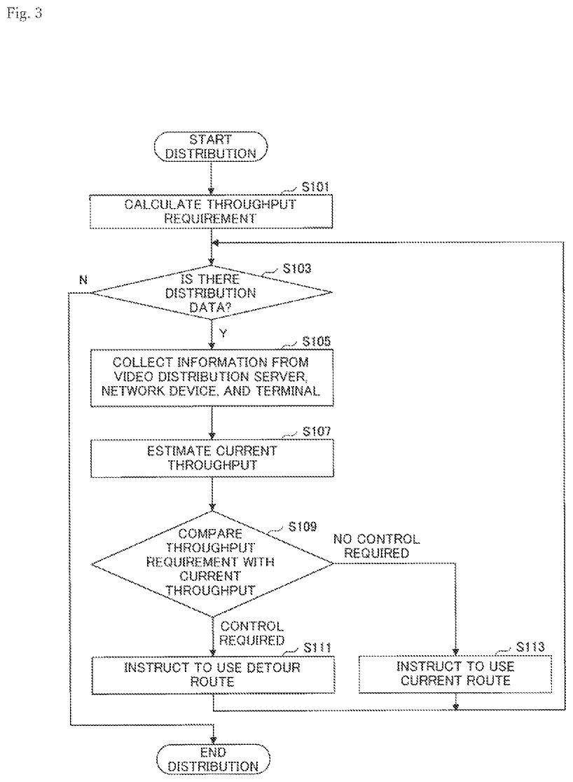

Next, an operation procedure in the example of configuration illustrated in FIG. 2 will be described with reference to the flowchart in FIG. 3.

First, the content distributor specifies a service session to be controlled in the video distribution and sets the requested QoE to start distribution of a certain video from the video distribution server 20 to the terminal 30. The service session to be specified refers to, for example, a service session from a specific terminal to be preferentially processed, a service session through a specific route, a service session in a specific time zone, or the like. Then, the communication quality requirement derivation unit 110 calculates the throughput requirement, which is a communication quality requirement, from attribute information of the video data to be distributed and the requested QoE (S101).

Specifically, the communication quality requirement derivation unit 110 derives a QoE level for a throughput under assumption that the attribute information of the data distributed from the video distribution server 20 to the terminal 30 has been properly adjusted according to the throughput, thereby generating a mapping function between throughput and QoE level in advance. The attribute information includes image quality (resolution), frame rate, audio coding bit rate, video coding bit rate, video compression standard, video length, download timing, and/or the like, which are selectable and prepared at the time of distribution. The mapping function is a relational expression of the correspondence between throughput and QoE level, and can be generated using, for example, a widely used QoE estimation model. For the QoE estimation model, for example, K. Yamagishi and T. Hayashi, “Parametric Quality-Estimation Model for Adaptive-Bitrate Streaming Services”, IEEE Transactions on Multimedia, 2017 may be referred to. Of the above attribute information, examples of attribute information that can be adjusted by the terminal 30 are image quality (resolution) and download timing. When the throughput is referred to as x, for such a video viewing situation without rebuffering occurring as a result of the terminal 30 properly adjusting the image quality and the download timing, a QoE level y corresponding to the throughput x can be found by applying the attribute information of the video at that time to the QoE estimation model. The communication quality requirement derivation unit 110 derives QoE levels y for the entire range of possible throughputs x, thereby generating a mapping function between throughput and QoE level. The communication quality requirement derivation unit 110 inputs the requested QoE to the mapping function generated in advance to derive the throughput requirement to be satisfied between the video distribution server 20 and the terminal 30.

Note that the communication quality requirement derivation unit 110 may derive the throughput requirement to be satisfied between the video distribution server 20 and the terminal 30 in consideration of a safety factor. Specifically, in consideration of the responsiveness of the control unit 140 and the fluctuations in throughput, the throughput requirement derived as described above may be multiplied by the safety factor.

Here, when the distribution of a specific service session ends and thus there is no distribution data (S103: N), the processing ends. When there is any distribution data of the specific service session (S103: Y), the following processing is performed.

The monitoring unit 120 collects pieces of information such as state values from the video distribution server 20 and the network device 40 and measured throughputs from the terminal 30 (S105), and estimates the current throughput of the specific service session (S107).

For example, the monitoring unit 120 may collect measured throughputs of service sessions between the video distribution server 20 and the terminal 30, exclude outliers from them, and calculate a weighted averaging of the resulting throughputs, thereby estimating the throughput of the current service session. Further, the monitoring unit 120 may collect, from the video distribution server 20 and the network device 40, state values (e.g., network usage rates) with which the throughput can be estimated, and estimate the throughput of the current service session based on a mapping function generated in advance. For example, the mapping function is a relational expression of the correspondence relationship between network usage rate and throughput. Through a preliminary experiment or the like, for a network usage rate of xᵢ of a device i, the maximum throughput yᵢ of communication passing through the device i is derived. The maximum throughput yᵢ for the entire range of possible network usage rates xᵢ of the device i is derived. Then, the minimum value of the maximum throughputs yᵢ found for all the devices (i=1, 2, . . . ) through which the specific service session passes, y=min(yᵢ), is found. Further, a quality measurement terminal(s) installed in the system may download pieces of measurement data transmitted to a quality measurement server to measure throughputs, exclude outliers from them, and calculate a weighted averaging of the resulting throughputs, thereby estimating the throughput of the current service session.

Next, the determination unit 130 compares the throughput requirement with the current throughput to determine whether control is required or not (S109). When the current throughput satisfies the throughput requirement, it is determined that control is not required. When the current throughput does not satisfy the throughput requirement, it is determined that control is required.

Note that instead of the communication quality requirement derivation unit 110 considering the safety factor, the determination unit 130 may consider the safety factor. Specifically, the determination unit 130 may use a second throughput requirement obtained by multiplying the throughput requirement by the safety factor in consideration of the responsiveness of the control unit 140 and the fluctuations in throughput.

When it is determined that the control is not required (S109: No control required), the control unit 140 instructs to use the communication route that has already been set (S113). In this case, the control unit 140 does not have to issue the instruction to the video distribution server 20 and the terminal 30. When it is determined that the control is required (S109: Control required), the control unit 140 instructs the video distribution server 20 and the terminal 30 to use the bypass (S111).

When the current throughput does not satisfy the throughput requirement, the control unit 140 detects where congestion occurs in a place where the bypass is set in advance, and issues a detour instruction for diverting the congestion point to the video distribution server 20, the terminal 30, and others so as to satisfy the throughput requirement in a service session basis. As a result, the communication route used for the specific service session is diverted to the preset bypass. The method of diverting the communication route to the bypass, for example, is implemented in a manner that an address for using the communication route at the start of viewing and an address for using the bypass are assigned to the video distribution server 20, and the control unit 140 causes the terminal 30 to switch the address of the video distribution server 20, resulting in the routing of the bypass in the network. Note that this method of diverting is an example, and the method of diverting is not limited to the above one as long as the throughput can be properly estimated to allow the service session to properly detour.

After that, the processing returns to S103, and the steps of processing by the monitoring unit 120 (S105, S107), the step of processing by the determination unit 130 (S109), and the steps of processing by the control unit 140 (S111, S113) are repeatedly performed until the distribution ends. Note that the flowchart of FIG. 3 illustrates an example in which a set of these steps of processing are repeated as long as there is any distribution data for the specific service session, but the timing of performing the set of the steps of processing is not limited to the example of FIG. 3, and may be performed only once every fixed time, or may be performed every viewing request.

### Second Embodiment

The description of the first embodiment is for an example in which a bypass to which a congestion point can be diverted is set in advance, and communication of a specific service session is guided to the bypass. In a second embodiment, an example will be described in which a priority transfer class is set using a technique such as DiffServ, and the communication of the specific service session is guided to the priority transfer class.

The configuration of a network control device 10 according to the second embodiment is the same as that of the first embodiment except for the function of the control unit 140. In the second embodiment, a priority transfer class that can be set in a packet of the specific service session when congestion occurs is set in the network device 40 in advance.

When the current throughput does not satisfy the throughput requirement, the control unit 140 instructs the network device 40 at the entrance of the network that accommodates the video distribution server 20 and the terminal 30 to set the priority transfer class in a packet to be transmitted between the video distribution server 20 and the terminal 30 for the specific service session. For example, when the current throughput does not satisfy the throughput requirement, the control unit 140 assigns a DSCP (DiffServ Code Point) for the priority transfer class to a packet whose source address is of the video distribution server 20 and whose destination address is of the terminal 30. As a result, the influence of congestion on the specific service session can be reduced.

### Third Embodiment

The description of the second embodiment is for an example in which the communication of a specific service session is guided to the priority transfer class. In the second embodiment, the influence of congestion on the specific service session can be reduced. However, when congestion occurs at multiple points in the network, the number of packets with the priority transfer class set increases, which leads to a possibility that the throughput requirement is not satisfied. In a third embodiment, an example will be described in which a technique such as IntServ is used to secure a communication resource and set a detour route each time a congestion point occurs.

The configuration of a network control device 10 according to the third embodiment is the same as that of the first embodiment except for the function of the control unit 140.

When the current throughput does not satisfy the throughput requirement, the control unit 140 instructs the network device 40 located between the video distribution server 20 and the terminal 30 to secure a communication resource for the detour route. When the communication resource for the detour route is secured, the control unit 140 instructs the network device 40 to divert the packet transmitted between the video distribution server 20 and the terminal 30 for the specific service session to the detour route. For example, when the current throughput does not satisfy the throughput requirement, the control unit 140 causes the terminal 30 to transmit a Path message of RSVP (Resource Reservation Protocol). When the terminal 30 receives a Resv message indicating that a communication resource has been secured in response to the Path message, the control unit 140 determines that the communication resource for the detour route has been secured. In the third embodiment, since the communication resource for the detour route is secured, the throughput requirement of the specific service session can be guaranteed and the requested QoE can be maintained.

As described above, according to the embodiment of the present invention, it is possible to maintain the requested QoE by monitoring the communication quality and individually performing network control based on the requested QoE in a service session basis.

<Example of Hardware Configuration>

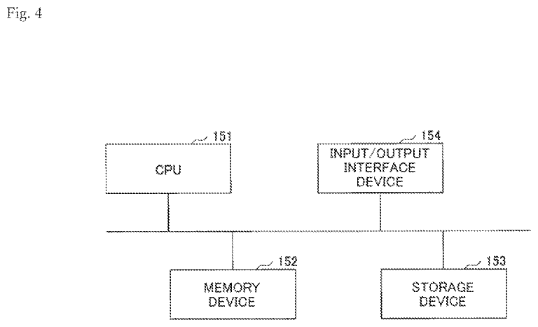

FIG. 4 is a diagram illustrating an example of hardware configuration of the network control device 10 according to the embodiments of the present invention. The network control device 10 may be a computer including a processor such as a CPU (Central Processing Unit) 151, a memory device 152 such as a RAM (Random Access Memory) and a ROM (Read Only Memory), and a storage device 153 such as a hard disk. For example, the functions and processing of the network control device 10 are implemented by the CPU 151 executing data or programs stored in the storage device 153 or the memory device 152. Further, information necessary for the network control device 10 may be input from an input/output interface device 154, and result(s) obtained by the network control device 10 may be output from the input/output interface device 154.

<Supplement>

For convenience of explanation, the network control device 10 according to the embodiments of the present invention is described above by using the functional block diagram. However, the network control device 10 according to the embodiments of the present invention may be implemented by hardware, software, or a combination thereof. For example, each embodiment of the present invention may be implemented by a program that causes a computer to implement the functions of the network control device 10 according to the embodiment of the present invention, a program that causes a computer to execute each procedure of the method according to the embodiment of the present invention, or the like. Further, the respective functional units may be used in combination as necessary. Further, the method according to the embodiments of the present invention may be performed in a different order from the order illustrated in the embodiments.

The method for performing network control based on a requested QoE for a specific service session is described above, but the present invention is not limited to the above embodiments, and various modifications and applications can be made within the scope of the claims.

### REFERENCE SIGNS LIST

10 Network control device
20 Video distribution server
30 Terminal
40 Network device
110 Communication quality requirement derivation unit
120 Monitoring unit
130 Determination unit
140 Control unit

1. A network control device comprising:
a communication quality requirement derivation unit configured to derive, for a specific service session between a server and a terminal, a communication quality requirement to be satisfied between the server and the terminal based on a requested quality of experience of the specific service session;
a monitoring unit configured to monitor a communication quality of the specific service session between the server and the terminal;
a determination unit configured to determine whether the communication quality of the specific service session satisfies the communication quality requirement derived for the specific service session; and
a control unit configured to control, when the communication quality of the specific service session does not satisfy the communication quality requirement derived for the specific service session, a communication route used for the specific service session between the server and the terminal so as to satisfy the communication quality requirement.

2. The network control device according to claim 1, wherein the communication quality requirement derivation unit derives a quality-of-experience level for a communication quality under assumption that attribute information of data distributed from the server to the terminal has been properly adjusted according to the communication quality to generate a mapping function between communication quality and quality-of-experience level, and inputs a requested quality of experience for the specific service session to the mapping function to derive the communication quality requirement to be satisfied between the server and the terminal.

3. The network control device according to claim 1, wherein the communication quality requirement derivation unit derives the communication quality requirement to be satisfied between the server and the terminal in consideration of a safety factor.

4. The network control device according to claim 1, wherein the control unit is configured to divert a communication route used for the specific service session to a detour route set in advance.

5. The network control device according to claim 1, wherein the control unit is configured to instruct a network device that accommodates the server and the terminal to set a priority transfer class in a packet to be transmitted between the server and the terminal for the specific service session.

6. The network control device according to claim 1, wherein the control unit is configured to instruct a network device located between the server and the terminal to secure a communication resource for a detour route, and instruct the network device to divert a packet transmitted between the server and the terminal for the specific service session to the detour route.

7. A network control method performed by a network control device, the method comprising the steps of:
deriving, for a specific service session between a server and a terminal, a communication quality requirement to be satisfied between the server and the terminal based on a requested quality of experience of the specific service session;
monitoring a communication quality of the specific service session between the server and the terminal;
determining whether the communication quality of the specific service session satisfies the communication quality requirement derived for the specific service session; and
controlling, when the communication quality of the specific service session does not satisfy the communication quality requirement derived for the specific service session, a communication route used for the specific service session between the server and the terminal so as to satisfy the communication quality requirement.

8. A program for causing a computer to function as a network control device that performs operations comprising:
deriving, for a specific service session between a server and a terminal, a communication quality requirement to be satisfied between the server and the terminal based on a requested quality of experience of the specific service session;
monitoring a communication quality of the specific service session between the server and the terminal;
determining whether the communication quality of the specific service session satisfies the communication quality requirement derived for the specific service session; and
controlling, when the communication quality of the specific service session does not satisfy the communication quality requirement derived for the specific service session, a communication route used for the specific service session between the server and the terminal so as to satisfy the communication quality requirement.
